(19) United States
(12) Patent Application Publication
(10) Pub. No.: US 2012/0253869 A1
(43) Pub. Date: Oct. 4, 2012

(54) System and Method for Process Improvement and Associated Products and Services

(76) Inventor: Rebecca Ansley, Westerville, OH (US)

(21) Appl. No.: 13/515,088

(22) PCT Filed: Dec. 13, 2010
(86) PCT No.: PCT/US10/60128

§ 371 Date: Jun. 11, 2012

Related U.S. Application Data
(60) Provisional application No. 61/286,294, filed on Dec. 14, 2009.

(51) Int. Cl. G06Q 10/06

(52) U.S. Cl. 705/7.12

(57) ABSTRACT

A method for identifying opportunities in a computer environment to improve a process comprising providing a tool for measuring and manipulating inputted and collected data. The measurements are scaled in large or small increments, convertible to other scales, and provided in units that are mixable. The tool allows a user to associate objects with other objects and resources. The tool provides the ability for a user to select, view, manipulate, analyze and graph effects to resources and other objects caused by incremental changes to an object to determine an amount of improvement of the process.

### FIELD OF THE INVENTION

The present invention relates generally to an improved method for review and analysis of process engineering/re-engineering and management, and more particularly to a system and method for examining and manipulating resource requirements for planning and execution activities at a fractional level.

### BACKGROUND OF THE INVENTION

Microsoft Project™, marketed by Microsoft Corporation, is a software application for resource planning/reporting that provides graphical presentations of project schedules, listing each task and assigning each task a duration or a work estimate. For most “Project Management” applications, the time units of years, quarters, months, days, and minutes are necessary and sufficient. Manipulating a program such as Microsoft Project where “units of measure” scale capabilities are further broken down to include seconds and milliseconds, as well as adding similarly scaled volume, length, temperature, mass, rate and other measurements as “units of measure” could open new markets (Process Engineering or Re-Engineering, Research and Development, and Quality Control, for example). For evaluating and analyzing scarce resources or dealing with tight operational or project measures, achieving increased operational or project capabilities may depend on carving a process resource into small (or larger) units, such as seconds to milliseconds. A need exists for a tool to evaluate the allocation of resources (people or machines or material or some combination) at a refined level.

Microsoft Visio® is not package-ready connectable to Microsoft Project. The programs can be used in concert through another program, such as Microsoft Excel®. Visio is a common tool used to represent technical drawings and data in many, if not most technical fields. A user can import dates and tasks from Project to create Visio timelines and Gantt charts (using an Add-on). The user is able to define symbols in Visio. A problem exists however, with easily transferring and moving back and forth between the Visio and Project programs. A need exists for assigning meanings that are transferrable between programs. A need exists to expand Visio capabilities to allow additional tracking, updating, and analysis capabilities.

Project includes an estimate-at-completion (EAC) feature (Work) and an actual-work-completed-to-date feature (Actual Work). The features allow a user to redefine the EAC and Actual Work as the project progresses. A problem exists in that the historic EAC and Actual Work are not preserved. A need exists to track Actual Work and EAC over time so Trend Analysis can be evaluated. For example: is EAC trending up or down or staying the same over time?—and how does that compare to Baseline EAC? How does Actual Work over time compare to Baseline Work over time?

Project includes a Cube Building Service that allows users to perform complex analysis of project data. The cubes divide the data into subsets that are defined by dimensions. Project creates an online analytical processing (OLAP) database used for data analysis reporting based on dimensions of data. A problem exists where there are characteristics of a task beyond the identified and defined dimensions that are necessary to segment resources. A need exists to be able to associate characteristics of a task with project specific data to connect and extract data to build and update OLAP cubes to analyze the data.

Accordingly, an object of the present invention is to provide a tool and a method and system incorporating such a tool that provides a solution to the problems associated with prior art approaches to resource planning, analysis and reporting.

### SUMMARY OF THE INVENTION

In an embodiment, the present invention adds other measurements to a software program such as Microsoft Project. The present invention is an improved method of using Microsoft Project by including, in addition to time that currently exists, other variable units of measure, and manipulating the data in small increments that may be a mixture of units of measure. Examples of units of measure in addition to time include but are not limited to temperature distance and length, capacity and volume, weight and mass, pressure, area, energy/work, light intensity, sound, radiation and the like. The present invention comprises a method of mathematically manipulating units of measure to predict improvement of a process by varying parameters, graphing the parameters and performing statistical analysis on variations.

In an embodiment, the present invention is an improved method of using Microsoft Project with Microsoft Visio by expanding and enhancing the functionality of the interface between the programs to provide two-way updates, custom definitions that transfer between programs, expanding layers, and allowing 3-D capabilities. In an embodiment, other programs, such as Clarity, SAP, Oracle and the like are expanded and enhanced using the tool of the present invention.

In an embodiment, the present invention is an improved method of using Microsoft Project to retain fields using the estimate-at-completion (EAC) feature to track changes made to update the schedule to show both current and historical trends.

In an embodiment, the present invention is an improved method of using Microsoft Project online analytical processing (OLAP) database by associating characteristics of a task with project specific data to connect and extract data to build and update OLAP cubes to analyze the data.

As used herein, “approximately” means within plus or minus 25% of the term it qualifies. The term “about” means between ½ and 2 times the term it qualifies.

As used herein, “small” means an increment from about 1.0 to about 0.000000000001 (pico- or about 10⁻¹²).

As used herein, “computer” includes any electronic or similar device having information processing capabilities.

As used herein, “symbols” includes drawings, animations, pictures, icons, movies, 3D representations, videos, shapes, equations, clip art, logos, charts, documents, text, hyperlinks and the like, whether existing or custom made.

As used herein, “mathematical functions” includes algebraic functions (functions containing addition, subtraction, division, multiplication, powers, roots, etc.), transcendental functions (trig and inverse trig functions, log and exponential functions, and hyperbolic and inverse hyperbolic functions, etc.) Longest-Path and the like.

As used herein, “Project” and “Visio” refer to Microsoft products, which are used in the examples, but also include products marketed by other companies that perform similar functions (scheduling, resource planning, drawing, integration, etc.), and those developed (by any entity) in the future. In addition, the present invention is not limited to process improvement and/or process engineering. Uses include any measurable act, such as communications, scientific, research and development, logistics, project management, construction, engineering, military, ERP, financial, capacity measurement, evaluation, analysis, data gathering, design, architecture, manufacturing, business management, integration, and the like.

The systems and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range or to be limited to the exact conversion to a different measuring system, such, but not limited to, as between inches and millimeters.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

Terms such as “top,” “bottom,” “right,” “left,” “above”, “under”, “side” and the like are words of convenience and are not to be construed as limiting.

### DETAILED DESCRIPTION OF THE DRAWINGS

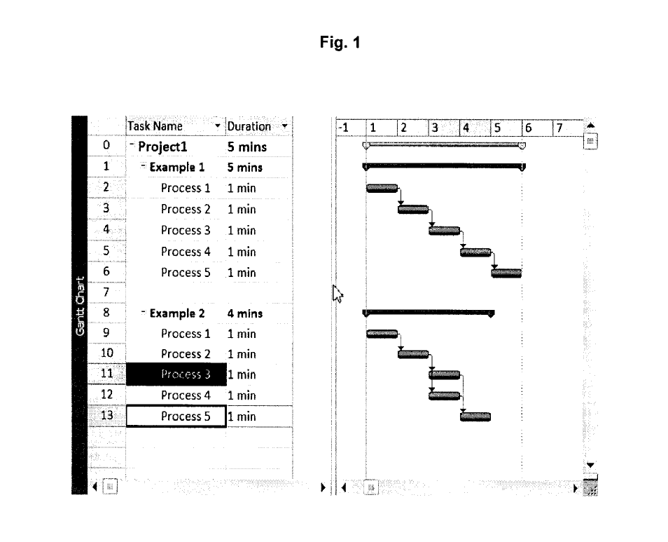

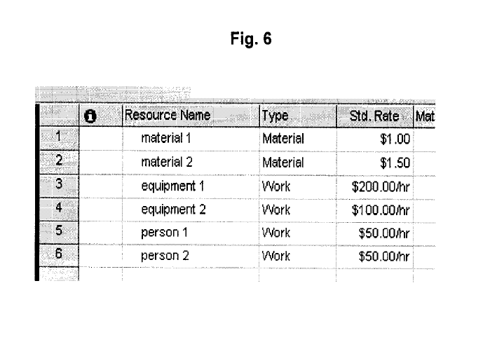

FIGS. 1-6 are screen print examples.

### DETAILED DESCRIPTION OF THE INVENTION

Each embodiment of the present invention is described below.

### Embodiment Number 1

### Expanding Microsoft Project's Units of Measure to Other Types of Measurements and Providing a Small Increment Scale Units

Microsoft Project's main target business application is “Managing Projects”. It includes resource allocation among projects. Project also includes various customizable fields (e.g., Number-nn, Duration-nn, Cost-nn, Start-nn, Finish-nn, Date-nn). It is not a tool to accomplish additional Business, Engineering, Research and Development, Scientific, Financial, Military, ERP, Data Collection, Evaluation, Analysis, or other similar applications (e.g. Process Improvement, Quality Control, LEAN, Six Sigma, Logistics Analysis, Business Process Analysis and Improvement, Stress Testing Evaluation, Computer or Equipment algorithmic evaluation and analysis, alternative or what-if analyses, whether those analysis are based on time, resource or material availability, cost). However, with the identified additional capability, it can easily be used for other Business, Engineering, Research and Development, Scientific, Financial, Military, ERP, Data Collection, Evaluation, Analysis, or other Applications. Currently Microsoft Project only manipulates “TIME” as a variable.

In an embodiment, the invention is an improved method for identifying opportunities to improve a process using Microsoft Project in a computer environment. The improvement comprises providing at least one object selected from the group consisting of time, temperature, distance, length, capacity, volume, weight, mass, pressure, area, energy, light intensity, sound, radiation, money and rate, scaled in large or small increments, convertible to other scales, and provided in units that are mixable that a user may associate objects and/or a resource and then vary the value of the objects/resources to determine an amount of improvement or change. The present invention includes a statistical function that allows collection of amounts of improvement or change resulting from incremental changes to an identified object and subjecting the data to statistical functions.

The present invention is applicable to fields that have a resource assigned (e.g., Work, Duration) as well as fields that do not have an assignment (e.g., Number-nn, Duration-nn). The present invention is applicable to fields currently existing in Project (or similar tool) or new fields, whether those new fields are custom or defined.

In an embodiment, the invention is an improved method for identifying opportunities to improve a process using Microsoft Project in a computer environment. The improvement comprises providing at least one object that does not have a specific type of unit of measure. In this case, the objects are not convertible to other scales and units are not mixable. The objects are scaled in large or small increments. The tool allows a user to associate at least one object with at least one other object and a resource and then vary the value of the objects to determine an amount of improvement or change. The tool includes a statistical function that allows collection of amounts of improvement/change resulting from incremental changes to an identified object and subjecting the data to statistical functions.

In an embodiment, the invention comprises a computer program product comprising a tangible computer readable medium including computer executable instructions embedded in the medium for identifying opportunities to improve a process. The instructions create a tool comprising objects selected from the group consisting of time, temperature, distance, length, capacity, volume, weight, mass, pressure, area, energy, light intensity, sound, radiation and rate, preferably in a pull-down menu presented to the user. The objects are scaled in large or small increments, convertible to other scales, and provided in units that are mixable. The tool provides the ability for a user to select, view, manipulate, analyze and graph effects both to the process/task itself as well as to an identified resource associated with an object caused by incremental changes to the objects to determine an amount of improvement of the process.

In an embodiment, the invention comprises a computer program product comprising a tangible computer readable medium including computer executable instructions embedded in the medium for identifying opportunities to improve a process. The instructions create a tool comprising objects that do not have a specific type of unit of measure. In this case, the objects are not convertible to other scales and units are not mixable. The objects are scaled in large or small increments. The present invention provides the ability for a user to select, view, manipulate, analyze and graph effects, both to the process/task itself as well as to an identified resource (if there is an assignment) associated with an object, caused by incremental changes to the objects to determine an amount of improvement of the process.

In an embodiment that adds other measurements capable of manipulation to Project, the present invention is an improved method of using, in addition to time, other variable units of measure, such as but not limited to: temperature, distance and length, capacity and volume, weight and mass, pressure, area, energy/work, light intensity, sound, radiation and the like. The invention comprises a method of expressing the units of measure in increments, such as but not limited to (each listing includes “and parts thereof”):

For time: centuries, decades, years, months, days, hours, minutes, seconds, and the like; for temperature: degrees, and the like; for weight and mass: kilograms, tons, pounds, ounces, moles, and the like; for distance and length: light-years, meters, miles, yards, feet, inches, furlongs, fathoms, and the like; for capacity and volume: cubic yards, cubic feet, cubic meters, liters, gallons, quarts, pints, ounces barrels, pecks, bushels, and the like; for area: square meters, acres, square miles, hectacres, and the like; for pressure: pascals, bars, pound-force/square inch, torrs, and the like; for luminous intensity: candles, lumens, and the like; for energy/work: amperes, joules, volts, watts, newtons, and the like; for sound: bels, decibels, nepers and the like; for radiation: rads and the like.

The invention uses units of measure in any scale, such as US, International System of Units/Metric, (including Kelvin, Richter, other earth science for volcano, tornados, hurricanes, light-years; military), etc.

The present invention comprises a method of mixing units of measures for a given type of unit, such as but not limited to selecting from: years, months, days, hours, minutes, and seconds; kilograms, tons, pounds, ounces, and moles; meters, miles, yards, feet, inches, and yards; liters, gallons, quarts, pints, and ounces; pascals, bars, pound-force/square inch, and torrs; and the like.

The present invention comprises a method of mathematically manipulating units of measure (in addition to time) to predict improvement of a process by varying parameters, graphing the parameters and performing statistical analysis on variations.

The present invention comprises a method of mathematically manipulating combined types of units (e.g. length and time to get feet per second), to predict improvement of a process by varying parameters, graphing the parameters and performing analysis on variations.

In an embodiment, the present invention expands Microsoft Project's units of time measure to a much lower unit of measure as well as, a much larger unit of measure. The current units of measure are Years, Half-Years, Quarters, Months, Thirds of Months, Weeks, Days, Hours, and Minutes. The present invention includes additional increments for units of time measure: seconds, 0.1 seconds, 0.01 seconds, 0.001 seconds, 0.0001 seconds, 0.00001 seconds, etc.

In an embodiment, the invention expands Microsoft Project's units of measure to other types of measurements, such as:
i. measurements of volume—both US (e.g. gallons, quarts, cups, teaspoons, etc down to very small parts) and Metric (e.g. liters, 0.1 liters, etc down to very small parts);
ii. measurements of length—both US (e.g. miles, feet, inches, ⅛ inch, etc) and Metric (e.g. meters, 0.1 meters, etc);
iii. measurements of mass—both US (e.g. tons, pounds, etc) and Metric (e.g. grams, etc);
iv. measurements of temperature—both US (e.g. degrees Fahrenheit) and Metric (e.g. degrees Celsius); and
v. measurements of rates—both US and Metric (e.g. length/volume; volume/time, etc).

In an embodiment, the present invention adds numerous core and custom fields, views, filters, etc, such as but not limited to:
i. Views: Gantt, Resource Usage, Task Usage, Resource Sheet; and
ii. Fields: dates, duration, work, cost, percentage, variance, summary, rates, number, longest-path, longest-path-start, longest-path-finish, longest-path-predecessor, longest-path-successor.

In an embodiment, the present invention extends functionality with the added units of measurements—as well as combined units of measurement:
i. add the capability to summarize by all the various units of measurement—and view those sums in multiple “logical” manners (e.g. 1 hour 3 min 5.673 seconds OR 63 min 5.673 seconds OR 3785.673 seconds OR 1.xxx hours OR 0.xxx days; 1 gal/minute OR xxx liter/second);
ii. ability to convert between US and metric and other measurements (e.g. gal conversion to liters);
iii. add the capability of other numeric functions (e.g. AVG, MIN, MAX, Summary, “Longest Path”—a “Duration-like” calculation) at the summary against those measurements—and view those results in multiple logical manners (e.g. 1 hour 3 min 5.674 seconds OR 63 min 5.673 seconds);
iv. add the capability of other numeric functions (e.g. those applying to individual and/or combined units of measure, logarithmic, algorithmic, scientific, transformational, those applying to units of measure where “simple mathematical formulas” are not indicative of their logical mathematical properties like hurricane force) at the individual and summary task levels;
v. add the capability of statistical functions (e.g. variance, sigma, mean)—at the summary level;
vi. allow those added capabilities to be used in macros, functions, equations, filters, etc (e.g. currently define a custom field to be the result of a function (display a flag if current is greater than baseline date minus 2 weeks—and it is not complete . . . i.e.—due within 2 weeks and not yet done OR display a flag if Longest-Path is greater than 0.000000001 seconds OR display a flag if Longest-Path is greater than 9.001 meters);
vii. allow those capabilities to be used in any way that Microsoft Project current uses other similar fields (e.g. Earned Value, IRR, etc);
viii. add other appropriate functionality based on the specifics of the unit of measure (e.g. rate of increase);
ix. add capability of base-lining those measurements—not just measurements related to assignments, and all comparisons to baseline (variance, Earned Value, etc);
x. create View Capability based on those other units of measure (e.g. Gantt and Usage views currently use time in the “picture” part of the view) the present invention provides the capability to use the other units of measure in the “picture” part of the view that may or may not be Gantt- or Usage-type views, depending on the units of measure. The Views may have very different characteristics;
xi. create View Capability based on objects that do not have a specific type of unit of measure (e.g. Gantt views would show “relative positioning”—but without a “characteristic” (like time or length) associated with it;
xii. showing relationships between processes/tasks may be different when using different units of measure or combined units of measure (e.g. a time relationship between 2 tasks on a time-scale is currently represented with an arrow; a relationship between 2 tasks/processes/events on a logarithmic-scale may be represented in an entirely different way, such as, but not limited to, dashed or dotted lines, different colors (or shade or intensity of a color) on a line (e.g. green to yellow to red), area differential—shaded area under a curve—with shading being different colors (or intensity or shades of a color) or different line patterns (e.g. diagonal lines or dots), and the like);
xiii. add the capability of “3-D picture” capability to all units of measure—with filtering/different colors etc.;
   1. e.g. for Resource Usage Views—3D capability would show “stacked” # hours per week against various tasks . . . If Becky has 15 hours per week on Task A and 45 hours per week on Task B—can look at all Tasks or just Task B and see visually the hours associated with those tasks;
   2. e.g. for Task Usage Views—3D capability would show how much total resources are being used per task;
   3. e.g. for “rates” (e.g. length/volume; volume/time) could use 3-D picture to show these—since linear would not represent well; and
   4. add the capability to other “graphing” systems and systems that “operate” on data;
xiv. allow “cost” to be generated/extrapolated using these new units of measure;
xv. add ability to have multiple “picture” views visible simultaneously such that a Task that has Resources measured in 2 (or more) units of measure (for example time and length; rate of change for multiple elements over time) would be able to display multiple views simultaneously (one for time and 1 for length; one for time; 1 for each element's characteristics over time);
xvi. add ability to have three or more views simultaneously. In Project, only two views are available: one of the views is subservient to the other view. For example—the second view will provide additional information about the task that is selected in the first view. The present invention allows two or more totally independent views to be displayed simultaneously—with the ability to have three views showing (e.g., two (or more) “masters” views and one view that is a subservient view to one of the “master” views); and
xvii. add ability to have multiple usage and/or Gantt views (and/or new view types) visible simultaneously—either horizontally or vertically—or both.

The following examples illustrate this embodiment:

Example A: A manufacturer of cable lengths for a customer has been provided a tolerance for the lengths of +/−½ inch. The invention allows a user to vary the rate of the cutting machine and the speed of the cable feed to manipulate the average length of cables cut so that the maximum speed of the process produces cables within the tolerance levels.

Example B: a baker requires an oven to bake an item. The cost of running the oven is $20/hr. The time to bake the item at 200° F. is longer than the time required to bake the item at 400° F. By manipulating both the time and temperature variables in small scale increments, the baker can determine the optimum temperature to bake the item at the lowest cost. The invention can be used to show statistics on the variations, such as time to heat the oven to the optimum temperature, cooling rates, etc.

Example C: There are multiple “things” that need moved from Point A to Point F. There are various modes of transportation available—each having different characteristics such as time, cost, availability, conduciveness to materials being transported and/or terrain. Different paths are possible between Point A and Point F, with various stopping points. Some of the “things” that need moved need to be converged at Point C while others do not need further convergence prior to Point F. Some of the things need to arrive at Point C earlier than others. Some of the things need to arrive at Point F earlier than others. With this invention, multiple “picture views”—with one view tracking distance with its stopping points and another view tracking time—with costs, materials being transported, and modes of transportation as potential additional values on the views or additional views could be developed. By displaying these Views simultaneously and “over” one another—analysis and evaluation are enhanced. Multiple Alternatives for the various modes of transportation, paths, stopping points, availability, etc could be developed and analyzed prior to deployment. The alternative selected could then be tracked and updated by inputting actuals to compare to baselines and current plan.

Example D: When trying to find bottlenecks in capacity processing, “processes” (e.g. a data base call) are at very small parts of seconds—so a time-unit is needed at a very small unit. Also, the longest single process may not be in the bottleneck—the “longest path” may in fact be a series of very short processes. By finding and selecting processes—or a series of processes—to to change, it is possible to select the most productive processes to change or improve. Applications for this include gaming programs (who frequently need to wait for a hardware technical advance to introduce new capabilities), chip designers, any kind of computer systems performance tuning, equipment tuning (gaining 1 milli-second improvement could result in an order of magnitude output improvement with no additional cost).

Example E: An Architect is designing a “Green” building. The “electrical process” could be laid out in various alternatives with various electrical component characteristics. (This becomes even more powerful when combined with the Visio-Integration and Graphical-Symbol components of this invention.) The “Longest-Path”, as well as Summary, by material type, would be important components of alternative identification, evaluation, and analysis.

Example F: A Value-Stream Map is being developed for a process. In some cases, the process is measured in parts of seconds, in other cases, the process is measured in hours—or even days. This invention allows both very small parts of seconds to be recorded in the same field as days—and provides the capability of viewing Summary, for example, in a mixed mode of days, hours, minutes, and seconds. With Project's filtering and grouping capabilities, flags are set to identify value-adding vs. non-value-adding processes. With either current or claimed mathematical functions, value-adding processes are summarized, identified by performing-organizations, etc. Quite complicated Value-Stream-Maps or Value-Network-Maps are developed and analyzed. (This becomes even more powerful when combined with the Visio-Integration and Graphical-Symbol components of this invention).

Example G: “Longest-Path”. A user has 5 Processes or Tasks. Using “Time” as the unit of measure—Duration can be reduced by performing Process 3 and 4 simultaneously. Similarly—if “Duration”—as shown in this set of examples—was “Distance”—the “Longest-Path” could be reduced to “4” instead of “5”—which may be significant if a user is trying to minimize the distance electric current needs to travel in the design of a circuit board. As other examples: minimizing the longest piece of some material that is needed (shorter pieces of material are cheaper) optimum joining placement—better at certain points than other points, See FIG. 1).

In an embodiment, the present invention allows statistical analysis of the data, such as MIN/MAX, AVG, SD, etc, to help a user understand improvement. For example, a user may graph rate over time to determine a curve of the rates of change when an ingredient is added at varied milliseconds.

In an embodiment, the present invention provides additional mathematical or algorithmic function of the data, such as “Longest-Path.” “Longest-Path” is a similar concept to the Duration calculation in Project. It uses predecessor and successor relationships—at the Task, Sub-Task, and Summary levels—to determine the Longest-Path of a set-of-processes.

In an embodiment, the present invention provides additional “Units-of-Measure-Tiers” on the “TimeScale”. Currently, Project has 3 Tiers (all related to various measures of time). For units of measurement that are not “Time”—the “TimeScale” would display the appropriate units of measurement based on what is being displayed. If there is no specific unit of measurement (e.g. Number-02 has not been specifically identified as “length” or any other unit of measure)—only “numbers” would appear in the “TimeScale” with no identifying unit of measure.

In an embodiment, the present invention provides additional “TimeScale” Tiers within a single unit of measure. Project has 3 Tiers (all related to time). In the case of very small numbers, it would be useful to have additional layers (e.g. 4 or 5 Tiers)—no matter what unit of measure is being considered (e.g. Tier 1 may be “10's”, Tier 2 may be “1s”, Tier 3 may be “0.1s”, Tier 4 may be “0.01s”, Tier 5 may be “0.001s” and so on).

In an embodiment, the present invention adds other measurements to Project and allows manipulation of the data on a customizable scale down to very small (or very large) increments. The invention provides connecting Project with “data devices” and data bases that have data in them (like Excel or Access or SQL or Project Server®, and the like). While interfaces currently exist between Project and Excel and Access for existing functionality capabilities of Project, the present invention provides additional linking capabilities associated with the expanded capabilities, such as:
a. graphing tools (Visio or Excel or Crystal Reports®, owned by BUSINESS OBJECTS of FRANCE);
b. other data manipulation tools (Excel, OLAP Cubes, statistical tools);
c. other scheduling, ordering, materials management, ERP, financial, or analysis tools (Microsoft Dynamics®);
d. other data sharing tools (Outlook®, Microsoft Office®, SharePoint®, etc.); and
e. measuring tools that feed data gathered in a measuring tool into Microsoft Project—either through an intermediate operation/tool or directly. For example, a tool could measure the results of an (series of) operation(s) (e.g. cubic centimeters per milli-second) and feed it into Microsoft Project—populating the appropriate fields and adding tasks as appropriate.

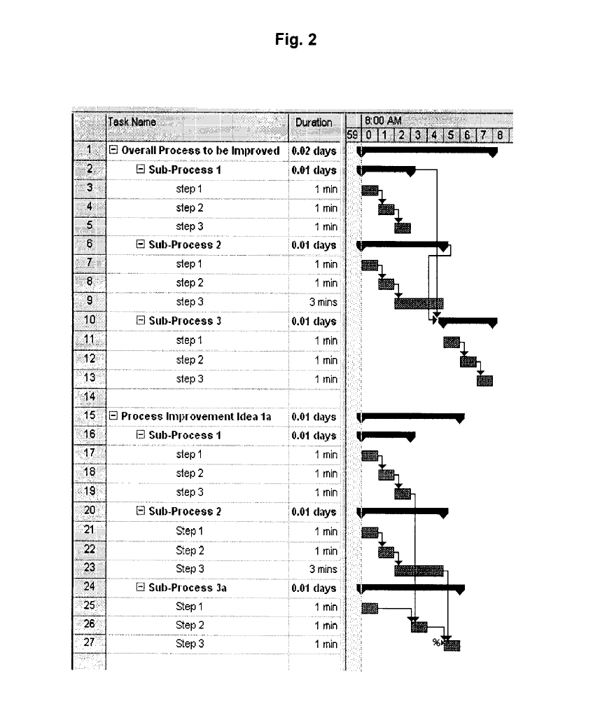

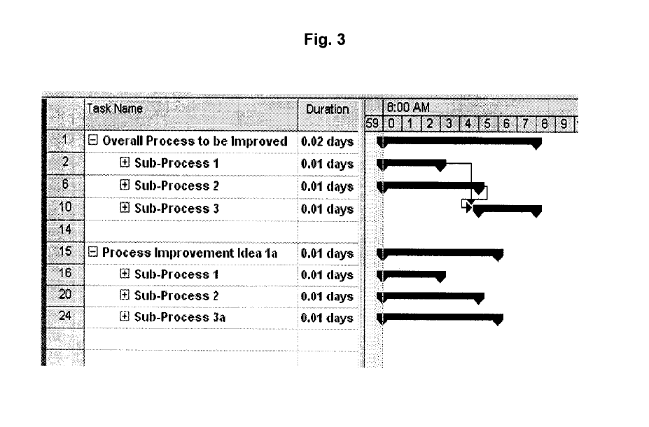

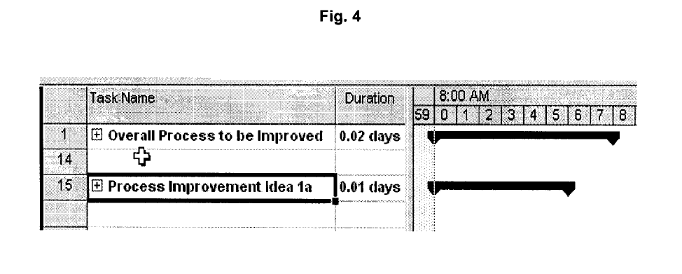

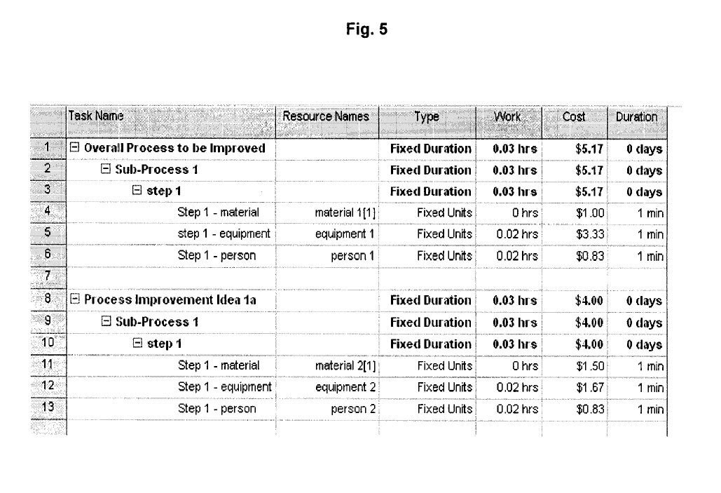

In an embodiment, the present invention provides users a tool to improve efficiency. The following examples are provided:
a. Process Improvement Example: Reduce the Interval for a Process
   i. Develop a “project plan” (or a sub-set of a project plan) for “the way it works today”;
      1. Each process step becomes a task, tasks can be grouped together under Summary Tasks, task dependencies are shown via links, and duration is identified.
      2. In the example—“Overall Process to be Improved”—the total length of time is 7 minutes.
      3. For many applications
         a. The “unit of time” may need to be seconds at the “step” level. For example—if attempting to improve the set-up time for equipment between one “run” and “the next run”—some steps may need to be measure in seconds. For example—if attempting to reduce the amount of time a barista takes to make a cup of specialized coffee, the steps may need to be measure in seconds—or even tenths of seconds. When operations are automated—the time measurement may need to be in the hundredths or thousandths of seconds.
   ii. Now develop a “project plan” (or a sub-set of a project plan) for “the way it might work better”;
      1. As stated earlier, each process step becomes a task, etc
      2. In the example (See FIG. 2)—“Process Improvement Idea 1—the total length of time is 5 minutes.
   iii. One of the advantages of using a Scheduling Tool like Microsoft Project is that the Processes/Sub-Processes can be “summarized” and/or “detailed” to show various levels of detail. See, for example, FIG. 3, showing Sub-Processes detail and Overall Process summary.
   iv. The “summary” function of Microsoft Project will automatically add up the corresponding lower levels of detail, which is another advantage of using a Scheduling Tool like Microsoft project. (In the examples shown in FIGS. 3 and 4, the invention would display Summary Duration in “minutes” or “seconds” instead of “days”).
   v. Another advantage is the ability to visually see the time-line to compare “the existing process” against “the improved process”.
   vi. Microsoft Project also allows Resources (e.g. equipment, people, material) to be assigned to Tasks, so the impact of Process changes on various Resources can also be viewed and analyzed.
   vii. With analysis, this can lead to more optimized resource utilization—whether those resources are equipment, people, or material; reduced WIP; reduced inventory; reduced Order Fulfillment Intervals, etc.
b. Process Improvement Example: Reduce the Overall Cost of a Process
   i. Develop a “project plan” (or a sub-set of a project plan) for “the way it works today”;
      1. Each process step becomes a task, tasks can be grouped together under Summary Tasks, task dependencies are shown via links, and cost of various materials/resources/equipment for each task is identified.
      2. In the example—“Overall Process to be Improved”—the total cost is $5.17.
   ii. Now develop a “project plan” (or a sub-set of a project plan) for “the way it might work better”;
      1. As stated earlier, each process step becomes a task, etc.
      2. In the example depicted in FIGS. 5 & 6. “Process Improvement Idea 1”, the total cost is $4.00.
   iii. Even though the Material used in the Improved Process is more expensive, the overall cost is lower because the equipment used in the Improved Process is less expensive.
   iv. The Cost is totaled at the Summary level, which is useful for comparing multiple process options.
   v. If a company has the ability to use multiple different Resource Options to fill an order, it can provide data for Optimal Resource Use as well as the cost to fulfill the order with other options.
c. Data Comparison and Evaluation.
   i. By expanding on the types of units able to be recorded and measured, other comparisons can be evaluated.
   ii. For example, this would satisfy the need to compare the output of 2 different processes in cubic feet per second, or parts per million, or liters per millisecond.
   iii. 2 different “summary tasks” (e.g. processes) can be compared for cost, rates, output, etc.
d. Data Collection & Reporting.
   i. Using the expanded Interface capabilities identified above, Microsoft Project could become a “direct” repository of data from experiments.
   ii. Process results (like test results) could be fed directly into Microsoft Project through the interface.
      1. Variances could be calculated automatically, exception and management reports produced, and all “management” capabilities currently available would be available;
      2. Earned Value analysis can also be extracted; and
      3. IRR and other financial formulas can also be extracted.

### Embodiment Number 2

In an embodiment, the present invention takes existing functionality within Microsoft Office Suite of products (Project, Visio, Excel, Access, Outlook, PowerPoint®, etc.) and other Microsoft products (e.g., Dynamics, Project Server, Report Server, SQL DataBases, OLAP cubes, etc.), as well as competing products, such as Clarity, SAP, Oracle and the like, and expands them, allowing for the products to be used for a totally different set of business applications and/or improvement to existing functionality. This does not apply specifically to the Microsoft Office Suite of products, but applies to any “office-like suite of products”, “scheduling system” (like Microsoft Project), ERP Systems (like Dynamics), any “drawing system” (like Microsoft Visio), any DataBase or Spreadsheet system (like Excel or Access or SQL), any data repository (e.g., Project Server), any integration system (like SharePoint), and any Reporting System (like Crystal Reports or SQL Report Server). This also does not apply specifically to “scheduling systems”, but extends to creating a system similar to Microsoft Project (e.g., a system that has “Tasks, Sub-Tasks, Summary Tasks”; “picture” and “usage” capabilities against those Tasks; numeric functions against those Tasks, Sub-Tasks, and Summary Tasks; custom define-able fields; baseline capabilities; reporting capabilities, graphing capabilities, etc). This also does not apply specifically to “scheduling systems”, but also to systems similar to Excel, Access, SQL, SQL Reporting Services, Crystal Reports (e.g. any system that “graphs” or “operates” on data).

Graphical Symbols for Microsoft Project.
a. Project currently has extremely limited ability to display graphical symbols. In “text” and “number” columns, there is an ability to display a limited set of graphical symbols (from a drop-down selection) when mapped to data-values. There is no ability to import or use additional symbols.
b. Project currently has extremely limited ability to display graphical symbols on “picture views” (e.g. Gantt Views). There is an ability to select from a limited set of graphical symbols, but they are not “tied-to” a Task. Wherever they are placed in the View is where they are.
c. Communicating with Team Member, Stakeholders, and Customers would be enhanced with an ability to tie graphical symbols to Task, Resource, and Project Characteristics (e.g. Text-n and Number-n) in all Views (e.g. Task, Gantt Bar, Timeline, and Column) and Reports, as well as free-form (not tied-to a Task or Resource or Project Characteristic).
d. Symbol Management (e.g. import, organization, group, selection, creation, tie-to-Task/Resource/Project-Characteristic, matching) is also needed. In an embodiment, with-respect-to Project-Visio Integration, Symbol Management/Distribution to Project, Visio and other Interfacing Products, Symbol Management within Project and other Interfacing Products that do not currently have Symbol Management, Symbol Management/Distribution between Project, Visio and other Interfacing Products (such as Clarity, SAP, Oracle and the like) is provided.
e. Specifically, Symbol management includes the ability to import Symbols from outside sources (symbols created or licensed or allowed-to-use by the user).
f. Specifically, Symbol management includes the ability to organize symbols, including “favorites” and “recently used” and “groupings/sub-groupings.”
g. “Groupings” are logical or physical grouping (e.g. 3 different types of punch presses are grouped as punch presses, or all the WIP and main Storerooms could be grouped as Storeroom). Within Groupings, there are multiple layers of sub-groupings. A “grouping” can be a process-type, where all tasks that have been identified as that process type use the same symbol automatically.
h. A “grouping” can also be a “WorkCenter”, which can be a physical-location (e.g. punch-press) or a work-group (e.g. accounting) or a logical-group (e.g. order-data-base). In addition, “groupings” definitions can further identify related fields, including additional “groupings”, which may have their own symbol set associated with them. For example, Task X and Task Y are both “Forklift Transport” “grouping-process-type”. The symbol “forklift” has been associated with grouping-process-type “forklift transport.” A grouping-physical-location has also been defined, with “punch-press”, “storeroom”, and “de-burring” each having their own symbols. The “grouping-process-type” of “forklift transport” could have “from-location” and “to-location” associated with it. For example, Task X and Y are both “forklift transport” “grouping-process-type”, but the “from-location” for Task X is “Storeroom” and the “to-location” for Task X is “punch-press”, while the “from-Location” for Task Y is “punch-press” and the “to-location for Task Y is “de-burring”.
i. A logical extension of the “WorkCenter” concept is “At-Location”. In this case, the process is performed “At” this WorkCenter.
j. Additional extensions of the WorkCenter concept are detailed below.
k. Ability to tie “symbols” to Tasks on the “Gantt” side. On the Gantt side, the View can be defined to show the grouping-process-type symbol and “at-location” (if there is one) “in” the task-bar, the “from-location” symbol on the right-side of the task bar, quantity and material (2 separate fields) can be shown under the task bar, and the Operator-type is be shown above the task bar. As tasks are added, changed, predecessors and successors changed, time-frames changed, etc., the Gantt side is automatically changed. Currently, Project allows multiple Views, with the ability to format each View slightly different, applying filters, groups, and different fields to the Gantt bars.
l. These capabilities provide a significant advantage with visual evaluation and analysis capabilities and auto-re-draw when changes are applied. By coupling this with the ability to display multiple Views simultaneously and see processes in different ways on different views, the present invention provides a major tool enhancement.
m. Prior to this, there were only a very few symbols that could be “closely matched” between the “Columns” on the left side of Project and the “picture” on the right side of Project. By providing symbols that can be used in both, additional error checking, evaluation and analysis can be accomplished. For example: filter that all Process-Group: Transport have a From-Location and To-Location specified as well as a Transport symbol specified. Custom fields can be also defined that highlight missing information. Task/Process input and changes are generally accomplished on the “column” View. When a user can see pictures “in the column”, faster and more error-free editing occurs.
n. Additionally and specifically, symbol management includes the ability to distribute and/or match symbols between Integrated Products (any Project and Visio—like program). For example, Visio has an extensive existing library of symbols. In the present invention, a symbol can be distributed to Project from Visio, and then managed in Project as if it had been imported or already included. A symbol that has been imported into Project (e.g. a supplier logo has been mapped to Tasks that are deliverables from that supplier) can be distributed to Visio from Project, and then managed in Visio as if it had been imported or already included. A symbol that has been imported in Project (e.g. a leased-symbol for a phone from an Icon-provider) can be matched with an existing Visio (phone) symbol, and then managed in both Visio and Project as “the same” (all characteristics transfer back and forth).
o. Specifically, symbol management includes the ability select symbols and tie them to Task, resource and Project characteristics in all Views and Reports.
p. While there are currently other Products that interface with Project and/or Visio (e.g. Microsoft's Excel, PowerPoint, Outlook, other Office products, Dynamics, SharePoint®, Report Server, Project Server), the present invention provides symbol management, symbol management distribution to other interfacing products, symbol management within those other products, and symbol management/distribution between those other products and between those other products and Project and/or Visio.
q. Project currently allows a Task Characteristic (e.g., Text-n, Resource) to be displayed in a Gantt chart, but only one characteristic on each side of the Bar (e.g. one characteristic on top of the Gantt bar). The present invention provides communication enhancement with team members, stakeholders, and customer with the ability to tie multiple characteristics on each “side” of the bar (e.g. three characteristics on top of the Gantt bar). This feature provides a mix of data values and graphical symbols.
r. The present invention provides the ability to distribute “symbol packages”. Users in different industries have interests in different symbols. A user using Project to manage a software development project, for example, may have little use for symbols specifically related to manufacturing or Value Stream Mapping or construction. A construction project manager, though, may find high value for both “construction” and “project-management” symbols.
s. The present invention provides the ability for users to add symbols. For example, a user may want to include their company (or their supplier's or customer's) logo; or perhaps they have a symbol they normally use to refer to a process; or they want to include pictures of their various parts, assemblies, or finished products. Meaningful graphics can significantly enhance the clarity of communication to executives, customers and team members.

Expand Enhancements, Expansions, and Extensions of Capabilities/Functionalities of Microsoft Project to an Interface with Visio (and Similar Programs).

This includes:
a. Units of time, volume, length, mass, temperature, measurement of rates, and all their corresponding capabilities (custom fields, macro results, etc derived from them)—plus all Enhancements, Expansions, and Extensions;
b. Very small and very large units of measure;
c. Additional calculations (e.g. Longest-Path);
d. Graphical Symbols and their management; and
e. WorkCenter-related concepts;
f. Visio contains the ability to create new symbols. The present invention includes the ability to take project symbols and “pair them” with a similar symbol in Visio and/or create a new symbol in Visio from the project symbol and/or create a new symbol in Project from a symbol in Visio whether it was created-in, imported-into, or existing-in Visio. For example, suppose a user imports a forklift symbol in Project. She can either “move” the forklift symbol to Visio or pair it with an existing “similar” forklift symbol in Visio. One of the features of the present invention is the ability to make symbols represented in various product's diagrams “similar-enough” to avoid confusion when users are looking at two different diagrams.

Enhance Capabilities/Functionalities of the Interface between the Microsoft Project and Visio and Similar Programs
a. Allow 2-way update capability (an update in Project updates appropriately into Visio; an update in Visio updates appropriately into Project);
b. Allow ability to select which tasks from Project are created and/or updated in Visio—and vice versa;
c. Ability to update Visio from Project. Not just task characteristics, but also move things around “physical-location-on-the-Visio-layout-wise” on Visio;
d. Ability to define “placement” in Visio from Project (and other products, such as Clarity, SAP, Oracle and the like);
e. “Placement Management” in Project (such as, but not limited to, from-, to-, at-WorkCenters) directs Visio. Once connected, Visio can update Project (e.g. a movement of the WorkCenter in Visio updates the Project “placement” characteristics);
f. Ability to include on “Directional arrow” the count of times that directional arrow is used in the Project Plan;
g. Ability to include on “directional arrows” some identifier (such as Task ID number, Number-n, Text-n, etc) to tie a Visio Graphic back to the Project Plan. For a process that has 15 steps that cycle back and forth between 4 “WorkCenters”, it is possible that “the same path” could be traversed multiple times. To communicate effectively what is happening in what order, the present invention ties those “travel arrows” with Tasks in Project. Since there may be Tasks in Project that are not shown in Visio, or Tasks may not be listed in strictly chronological order, a “numbering scheme” besides Task ID is provided;
h. Ability to define in Project the concept of WorkCenter. From- to- at-, as well as Directional Arrows between the WorkCenters. WorkCenters can be thought of as Physical, Logical, Organizational or something else. Example 1: a manufacturing floor with WorkCenters identified as High-Level or Detailed-level physical locations with the Directional arrows identifying product movement between those physical locations Example 2: a Major System Integration with WorkCenters tied to Major System Components with the Directional arrows identifying data movement between those Major System Components. Example 3: It could be a logistical map or Architectural Diagram with WorkCenters identified as the physical locations with Directional arrows identifying product movement. Directional arrows signify material-flow or information flow;
i. Using these concepts, Processes are defined in Project, with its ability to define precedence relationship, resource scheduling and utilization, filtering, grouping, etc.—and precedence diagramming (e.g. Gantt charts) show symbols along a time-scale (or distance-scale or both). Then—the Project Plan is integrated with Visio—to show graphical layouts in a more spatially designed format. Both graphical representations have value—they show different things in different ways. The symbol sets between the various diagrams are similar and matched. Updates in one auto-update the other. Updates in Project—to insert a Task or Process—are relatively easy to make. Update in Visio—to insert a Task—are more difficult. By tying these Products together—along with the new capabilities—not only can a user look at the same data in a variety of different ways—without re-drawing the diagram (different Views, different programs)—but any changes are automatically re-drawn.
j. A current-state can be developed, copied, and multiple potential future-states can be developed very quickly.
k. Visio contains the ability “pair” certain fields with certain symbols. For example—a Transport symbol may be tied to a “From-” field and a “To-” field on a file that is interfaced with Visio. The present invention provides the ability to “pair” fields in Project with fields in Visio with the ability to “show” certain fields in specific Visio drawing and “show” certain other fields in other Visio drawings. For example—one “view” of Visio shows—for symbol A—Text5 and for symbol B—Text6, Text7, and Text8.
l. The present invention provides the ability to “bring” all the fields in Project associated with a Task, a Resource, or a Project into Visio.
m. The present invention provides the ability to define a “Visio-location” and tie it to “WorkCenter” in Project.
n. If Project changes—Visio auto-re-draws also.
o. Bi-directional Arrows—as well as Directional Arrows are provided.
p. If an arrow is drawn is Visio and labeled, it is “linked” to Project “connector”.
q. If a “Visio-location” is moved in Visio (e.g. WorkCenter is moved 3 inches on the paper—Project automatically changes that location and all the Visio arrows to and from that location are either re-drawn automatically—or it could be changed manually—but it is still reflected in Project.
r. Data is updated in Visio (% complete, dates, work, duration, etc)—and it will update Project.
s. Ability to define “selected” graphics in Visio—that have a standard meaning and characterization in Project—and vice versa;
   i. These graphics would be “common” to particular fields (e.g. a symbol for a Storeroom, a symbol for transport, a symbol for process—the symbol set would include symbols common to industry/business/process improvement/education etc);
   ii. The present invention has custom field settings corresponding to those symbols. A change in Project would propagate back to Visio;
t. Allow “expanded layering” capabilities in Visio to interface with Project;
u. Allow “3-D” capabilities in Visio to interface with Project;
v. Allow “lock it in place” capabilities in Visio and its interface with Project;
   i. For example: a particular storeroom is in a particular physical place. Its “location” should be able to be locked in Visio and changes to Project would not change that unless the “associated field” is changed in Project (the location of that particular storeroom is moved, so Visio moves it).

Expand Visio Graphing Capabilities
a. Allow different graphics in Visio to have different “fields” associated with it—on 1 view (e.g. process symbols may have fields x, y, z showing, where transport symbols may have fields a, b, showing;
b. Allow different views to show different symbols, or different fields for the symbols;
   i. E.g. “View A” shows all processes identified—but only 1 field;
   ii. E.g. “View B” shows all processes identified—but shows fields x and y for process symbols and doesn't show any fields for transport symbols;
   iii. E.g. “View C” shows all process identified—but shows fields x for process symbols and shows fields a and b for transport symbols;
   iv. E.g. “View D” shows only process symbols;
   v. E.g. View E” shows only transport symbols;
c. Allow enhanced “layering” capabilities—with 3D visibility—allow ability to move around and within the 3D;
   i. E.g. allow the “transport” steps to be layered—so if an assembly goes from one place to another, and then somewhere else—the transport of the material can be examined in layers and from different angles;
   ii. Sometimes with certain fields identified, sometimes just the movement identified;
d. Allow “graphing” based on the various units of measures, their associated custom fields, macro results, etc;
   i. E.g. IRR, Earned Value etc;
   ii. E.g. volume, length, etc;
e. Allow 3-D capability based on selectable criteria;
   i. E.g. one view would show “height” based on time—but it would only show that “height” for transport functions, so that all transport functions would look like “stair-steps” for example, where all “make” functions would be flat. This can be used to analyze the total time involved in transport in a visual way and where those transports are physically occurring;
   ii. E.g. one view could show processes based on cost of the resources involved, so the most expensive equipment's (idle) time could be highlighted in red;
f. There are numerous core and custom fields etc impacted in the present invention, both on Project and Visio (and additional programs, such as Clarity, SAP, Oracle and the like).
g. Add animations and video capabilities to Visio.

Examples of Totally Different Sets of Business Applications
a. Today, users interface Microsoft Project with Visio to manage projects. It is not used or marketed as a tool to accomplish tasks that the present application can accomplish. The present invention can easily be used for the following additional business applications (examples only and are applicable to all programs, more not specified).
b. Provide 2-way schedule changes between Visio and Project for real-time schedule changes—and make them visible throughout the organization;
   i. Example 1—if a factory's schedule has been set for the day, but a high-priority order comes in, the scheduler could change the schedule using Visio (graphical easier to see, “grab and move”, etc), then the new Visio chart could be displayed on the factory floor.
   ii. Example 2—if a factory's schedule has been set for the day, but some parts are missing to complete the order, the scheduler could change the schedule using Visio, then the new Visio chart could be displayed on the factory floor. Reduces WIP.
   iii. Example 3—As employees on the floor have finished one of their tasks, they could provide update capability through Visio and then have that updated back into Project.
c. Process Improvement Example 1:
   i. By “playing” with various scenarios in Visio, and having that update Microsoft Project, Project's “other capabilities” (like the ability to summarize, provide different levels of detail, IRR, Earned Value, Cost, etc.) can be used to evaluate the various processes to determine which produces least cost, least time, etc.
   ii. Having the ability to see certain functions, such as selected processes or selected resources, provides the ability to focus on particular areas of interest
d. Process Improvement Example 2:
   i. By having ability to fix the physical location of something in Visio, a user can see physical movement of a product through a factory and see potential ways to improve speed through the process (e.g. create a “selected WIP storeroom”).
e. Process Improvement Example 3:
   i. By having the ability to do 3-D and layering in Visio, a user has the ability to see interactions from various angles, thereby providing another view for analysis.
f. Data Comparison and Evaluation
   i. By expanding on the types of units able to be graphed, other comparisons can be graphed.
   ii. For example, it is possible for projects to be interfaces with Visio, and use the better graphic capabilities of Visio (along with other tools and add-on's), to graph a nice-looking time-lines, milestones, etc in Visio. These are “time” based. Using other types of units (like length or cost), other types of visual graphics could be created. By using 3-D, things like volume or “rates” could be graphed.
   iii. For example, this would satisfy the need to compare the output of 2 different processes in cubic feet per second, or parts per million, or liters per millisecond.
   iv. 2 different “summary tasks” (e.g. processes) can be compared for cost, rates, output, etc.
g. Data Collection & Reporting
   i. Using the expanded Interface capabilities identified above, the present invention can be used as a direct repository of data from experiments.
   ii. Process results (like test results) could be fed directly into Microsoft Project through the interface:
      1. Variances could be calculated automatically, exception and management reports produced, and all management capabilities currently available would be available;
      2. Earned Value analysis can also be extracted; and
      3. IRR and other financial formulas can also be extracted.

### Embodiment Number 3

### Expand Enhancements, Expansions, and Extensions of Capabilities/Functionalities of Microsoft Project to an Interface with a Data Warehouse

a. Microsoft Project—even at the Enterprise Server level—does not contain Data Warehousing capabilities. Archiving is also not well supported, but the need for improved Archiving support could be reduced with a well-functioning Data Warehouse.
b. Key data, forming the core foundational Business Intelligence information, needs to be identified, classified, extracted, organized, transformed, summarized, and stored in a Data Warehouse; where it is then able to be retrieved and analyzed in a variety of ways. A well-designed Data Warehouse would provide good Business Intelligence, not just for long-term or high-level evaluation, but would be invaluable in the day-to-day evaluation of Project Status (e.g. Trend Analysis of Estimate-At-Completion [Work] for a particular Work-Group or Type-of-Work or even down to a particular Task or Assignment, showing both Past Performance and Projections). The current OLAP Cubes do not do this—they are a snapshot of a point-in-time. While a user can see what “was originally planned” (Baseline), he/she cannot see a trend—what has been happening over the last 13 weeks—(“was there a huge spike that was identified? Is slowly going down—or did it go down—and then start to rise again?”).
c. This includes:
   i. Units of time, volume, length, mass, temperature, measurement of rates, and all their corresponding capabilities (custom fields, macro results, etc derived from them)—plus all Enhancements, Expansions, and Extensions;
   ii. Plus all capabilities referenced in other parts of this patent application;
   iii. Plus all “Base capability” (e.g. tasks, assignments, resources, work, actual work, duration, costs, organization, etc).
d. Take “selected” fields—and put them into a Data Warehouse—so the how those values have changed over time can be selected, viewed, analyzed, and graphed.
e. The examples provided above are applicable to this embodiment.

Examples of Totally Different Sets of Business Applications
a. Today, Microsoft Project and Project Server reflect “now's” version of the project (along with several baseline versions)
b. The present invention provides the capability to analyze trends over time
   i. E.g., Earned Value trend over time.
   ii. E.g., EAC trend over time.
   iii. E.g., drill down to a particular task's trend over time (finish date, estimated work/duration, cost, etc).
   iv. Examples of evaluations provided by the present invention that are not visible in Project, are: EAC has increased 20% since last week; the target finish date has changed 3 times in the last 5 weeks; a task has been re-opened that was previously closed; the actual finish date of a task changed since last week; etc.
   v. This is needed—not just at the Project level—but at the Task level also.
c. Trend Analysis helps a user identify areas where a Project, Portfolio, or Program may be struggling (or pulling ahead), scope is changing, or additional support of some kind is needed.
d. A well-designed Data Warehouse can provide Business Intelligence about the Organization and its Projects.
e. If Maintenance and Support and other Operational Data is collected into the Data Warehouse, a powerful analysis and evaluation tool is made available. For example, if Maintenance and Support and Administrative tasks had their own Project Plans, and were entered into Project Server, and time was gathered against them, then that data was also transformed into the Data Warehouse, then, with the capabilities from Embodiment 4, an organization could do analysis and trends on:
   i. Project work vs. maintenance work vs. administrative work; by work-group; by module; by Portfolio; by Program.
   ii. Percentage of over-all project time spent on Requirements and Design by Module vs. amount of Maintenance and Support for that Module.
   iii. Trends of amount of overall Maintenance and Support related to a particular Module (vs. other Modules) or Work-Group (vs. other Work-Groups) or Sponsor (vs. other Sponsors).
f. By “keeping” selected fields, on a “weekly” basis, reports can be generated where “history does not change” (e.g.—on Hillclimbers—if 30 out of 50 tasks were reported completed last week; next week's report will also report 30/50 tasks completed for that already reported week). It is possible with the current version of Microsoft Project that this week a user can generate a report that 35/52 tasks were completed last week. With the current version of Microsoft Project, a user cannot see that last week EAC was 100 and this week EAC is 125. Data must be maintained in a “historical data base” for tracking.
g. By “keeping” selected fields, a user can see if a People Resource has (e.g.):
   i. Was a Consultant for this period of time—and for this period of time was an Employee;
   ii. Had this “Cost” over these periods;
   iii. Was in different Organizations for these periods of time—sometimes in multiple organizations simultaneously—and perhaps cost-rate was different or was a consultant for one Organization and a part-time employee for another;
   iv. At a later time, when analyzing data based on Organization, a user may not want the report to reflect “where that person is now”. The user may want to know “who did the person report to then”, or may want to report that xx hours of Consulting time were used (but since that person is now an Employee, the user cannot make that determination).
h. Allow reporting from this Data Warehouse so trends can be seen.
i. Allow reporting to be able to get Data both from both current and historical.

### Embodiment Number 4

a. The OLAP cubes used in conjunction with Project Server provide a lot of Dimensional data, but are lacking some of the base capability needed for collecting good Project/Program/Portfolio-Related Business Intelligence in an easy manner.
b. Many organizations may work on many projects simultaneously. It is extra-ordinarily burdensome to create and manage a separate project plan for each project they touch. It would be highly advantageous, for a resource manager for example, to have one plan that covers all the work (tasks for many projects, programs, and portfolios) that they are responsible for—and have “task identifiers” that can be used to identify the appropriate categories.
c. In the same way, some projects or tasks within a project plan, are logically related to multiple programs and/or portfolios.
d. Many organizations have used the project characteristics as identifiers, but, that can become extra-ordinarily burdensome (an overwhelming number of separate project plans) and in fact may not work at all (multiple programs and/or portfolios)
e. The present invention provides a mechanism for developing appropriate task identifiers, coding them in the project plans, getting the data into project server and the OLAP Cube (and data warehouse [embodiment 3]), and pulling the data into reports such that the project manager, portfolio manager, program manager, or any other appropriate person, can see full data associated with a project (or program or portfolio) regardless of where that task's time is recorded.
f. Task identifiers will be a task custom code. If using an enterprise solution (like Project Server), a task enterprise custom code.
g. The number of types of custom codes will be somewhat variable based on a user's business, and how programs and portfolios and projects are structured.
h. This is an example of a set of task custom codes that prove useful in the software development industry:
   i. Task Custom Code: Task Type. These can have multiple levels of hierarchy For example:
      1. Requirements
      2. Design
      3. Development
      4. Testing
         a. Unit Testing
         b. Integration Testing
         c. Stress Testing
      5. Support
         a. Tier 1
         b. Tier 2
         c. Tier 3
         d. Tier 4
      6. Admin
         a. Leave
         i. Vacation
         ii. Sick
         iii. Holiday
         b. Organizational Overhead
         i. Quality Training
         ii. Organizational Team Meetings
   ii. Task Custom Code: Task Project/Portfolio/Program. These can have multiple levels of hierarchy. This may also be split up into multiple different Task Custom Codes depending on how the organization views/splits Portfolios and Programs. Note—“Project” does not mean “Project Plan”—it refers to the Project that has been authorized by the organization. A Project could consist of many Project Plans spanning multiple years, or could consist of a single Project Plan, or it could be a very small Project—but that is spread out among several Project Plans (Project Plans owned by the Resource Manager—and many Resource Managers involved). For example:
      1. Portfolio A: Deliver Contract A
         a. Project A-1—Develop for US Market
         b. Project A-2—Modify for European Market
         c. Project A-3—Modify for Asia-Pacific Market
         i. Project A-3-1—China
         ii. Project A-3-2—India
         iii. Project A-3-3—Japan
         d. Project A-4—Modify for remaining North and South American Market
      2. Portfolio B: Deliver Contract B
         a. Project B-1—Develop for Asia-Pacific Market
         b. Project B-2—Modify for US Market
         c. Project B-3—Modify for remaining North and South American Market
         d. Project b-4—Modify for European Market
      3. Support
      4. Admin
      5. Note that Support and Admin are both here and in Task Custom Code: Task Type. If the “Task Custom Code: Task Project/Portfolio/Program” consists—in general—of “Project work”—a user will need “something for this Task Custom Code” that can logically tie Support and Admin to. Note: each Task will need to have “something” in each of the Task Custom Codes.
   iii. Task Custom Code: Task Module-Affected. These can have multiple levels of hierarchy. In the case of Software-Application-Development—this would be the “Module” For example:
      1. PeopleSoft Finance
         a. GL
         b. Grants
         c. Procurement
      2. PeopleSoft HR
         a. Tax
         b. Payroll
      3. Admin
      4. Note that Admin is here, but Support is not.
         a. Admin will—in general—not be tied to a Module—Vacation is not logically associated with PeopleSoft Finance for example
         b. Support may in fact be tied to a Module. A user will likely want to know how much Support is being performed on PeopleSoft Finance—Procurement vs. PeopleSoft Finance—GL.
      5. This becomes “different” when dealing with an Infrastructure team, for example. This is NOT Organization performing the work—and may not even be Organization that the work is being done for.
   iv. In general, when setting up these codes, one needs to consider: what do I want to be able to analyze, evaluate, and report? It is tightly coupled with business intelligence and data warehousing. It is best to have the fewest number of fields that are logical—each field will need filled in for each task—although it is possible to write macros that auto-fill the fields. When setting up these codes, one needs to make sure the schema “logically fits” for multiple different types of organizations (application development and Infrastructure for example). Aside from the possibility of splitting the Project/Portfolio/Program field—these 3 fields—coupled with already existing fields—should be enough to satisfy many if not most applications in this space. The preceding does not limit the present invention, but rather is presented to encourage the implementer to consider further before adding additional fields for this purpose.
i. Special set-up or coding need to be done to bring these new fields into the OLAP Cubes as dimensions.
j. Special set-up or coding need done to pull data from multiple project plans and filter based on the custom codes. For example, let's say a user is a Project Manager, and your project's data is included in 5 different project plans. Two of those project plans include other project's data. A user might create a Master Project Plan with those 5 project plans linked into it, and then develop filters that only show your project's data. It is also possible to create a front-end to Project Server that will provide “commonly used reporting” or “standard reporting” across the enterprise that goes into the Project Server data base and pulls data directly from the underlying data bases.
k. That Front-End “commonly used reporting” could include reports for different purposes—Team Members, Resource Managers, Project Managers, Portfolio Managers, and Project Directors. It could include the business intelligence and analysis capabilities of a combination of the Project Server DataBase (what it is “now”), a Project Server Weekly-Official-Reporting DataBase, the Project Server Archive DataBase (if appropriate) and the Data Warehouse.

A Project Server Weekly-Official-Reporting DataBase is a useful snapshot to keep. In a well-functioning organization, changes could be made daily—or even multiple times during the day—to a Project plan—reflecting the latest information. Perhaps new target dates have been identified, certain milestones have been completed, and a re-work of a section of a project is being under-taken. It is normally advantageous to pick “a day/time of the week” where—it is known by all that an official snapshot will be taken. Time needs to be accepted and plans updated and re-worked, and official reports will be generated based-on that data. It frees a manager to make changes during the in-between time without fear that those changes will be used when they are not appropriate yet for use.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

1. A computer-implemented method for manipulating inputted and collected data associated with an engineering or project management process comprising the steps of:
a) collecting the data at timed intervals and storing the data in a data warehouse, the data comprising at least one object selected from the group consisting of effort, duration, points, time, temperature, distance, length, capacity, volume, weight, mass, pressure, area, energy, light intensity, sound, radiation, money and rate, the object scaled in large or small increments, convertible to other scales, and provided in units that are mixable;
b) identifying, classifying, extracting, organizing, transforming, summarizing, and storing the data in the data warehouse in an online analytical processing (OLAP) cube;
c) selecting at least one object, selecting a time interval for that object, and associating the object with at least one of a task, a resource and a project,
d) subjecting the data in the OLAP cube that was collected for the time interval for the object associated with the task, resource or project to at least one mathematical function and statistical function to show current, future and historical trends for the object; and
e) manipulating the data in the OLAP cube related to the task, resource or project to obtain a desired future value of the object.

2. The method of claim 1 further comprising varying values of the predicted values of future trends for the objects to determine an amount of improvement or change of the engineering or project management process.

3. The method of claim 1 wherein the data is collected by at least one sensor associated with the engineering or project management process.

4. The method of claim 2 wherein the improvement or change is evaluated using small incremental changes to the data.

5. The method of claim 1 wherein a symbol represents the object, task, resource or project.

6. The method of claim 5 wherein each symbol is linked to at least one task, resource and project.

7. The method of claim 1 wherein objects are viewable both independently and in aggregate and linked to at least one symbol, the symbol viewable both independently and in aggregate.

8. (canceled)

9. The method of claim 1 further comprising the step of providing a view mode for viewing a multitude of characteristics or objects identified with at least one object, task, resource and project; said characteristic viewable in at least 5 areas around the object, task, resource and project.

10. (canceled)

11. The method of claim 1 wherein the data from two objects associated with the task, resource or project are manipulated to show multiple future trends to determine an optimum future value for a third object.

12. The method of claim 1 further comprising the steps of linking Microsoft Project to Microsoft Visio and updating Project and Visio to include convertible and mixable objects scaled in small increments that are associated with at least one task, resource and a project, the objects in Visio and Project measured and subjected to at least one mathematical function and statistical function.

13. The method of claim 12 wherein an update made in Project updates in Visio and vice-versa.

14. The method of claim 12 further comprising updating collected data and displaying a graphical view of that data simultaneously in each program.

15. The method of claim 12 wherein at least one independent symbol is linked to each object, task, resource and project; said symbol portable between programs.

16. The method of claim 12 including a 3D layering function for each object, task, resource and project.

17. The method of claim 12 further comprising the step of linking Visio and Project to other computer programs.

18. The method of claim 1 further comprising the step of associating the task with a task type and an effected module.

19. The method of claim 18 further comprising manipulating the data in the OLAP cube for at least two objects associated with the task to determine an amount of improvement of the effected module.

20. The method of claim 19 wherein the task association data stored in the database are manipulated to show multiple future trends to determine an optimum improvement of the effected module.
